(19) United States
(12) Patent Application Publication
(10) Pub. No.: US 2021/0287233 A1
(43) Pub. Date: Sep. 16, 2021

(54) COMMERCIAL ROBOT RUN TIME OPTIMIZATION USING ANALYSIS OF VARIANCE METHOD

(71) Applicant: INTERNATIONAL BUSINESS MACHINES CORPORATION, Armonk, NY (US)

(72) Inventors: Craig M. Trim, Ventura, CA (US); Shikhar Kwatra, Durham, NC (US); Zachary A. Silverstein, Jacksonville, FL (US); Martin G. Keen, Cary, NC (US)

(21) Appl. No.: 16/817,271

(22) Filed: Mar. 12, 2020

(51) Int. Cl. G06Q 30/02; G06F 16/22; G01C 21/00; G01C 21/20

(52) U.S. Cl. CPC G06Q 30/0201; G06F 16/2282; G06N 20/00; G01C 21/206; G01C 21/005

(57) ABSTRACT

A processor maps a plurality of obstructions in a space to generate a map of obstructions, where the obstructions comprise data related to temporary obstacles during an operation of the commercial robot, and where the space comprises from a plurality of macro locations. The processor detects foot traffic and obstruction abnormalities in each of the plurality of macro locations from the map of obstructions. The processor compiles a correlation matrix from a set of feature vectors, wherein the set of feature vectors derived from the map of obstructions in the space. The processor determines a minimum duration time and a weekday for each of the plurality of macro locations based on the correlation matrix, where the minimum duration time is an optimum time and a weekday to dispatch the commercial robot in each of the plurality of macro locations.

### BACKGROUND

The present invention relates, generally, to the field of computing, and more particularly to commercial robot run time optimization using analysis of variance (ANOVA) method.

A commercial robot is a machine that may be programmable by a computer and capable of carrying out a series of actions automatically. The commercial robot may be guided by an external control device or the control may be embedded within. Commercial robots may be autonomous or semi-autonomous that perform tasks in large areas such as cleaning, package delivery, or video surveillance. These robots are used, for example, in airports, hospitals, and factory shop floors.

### SUMMARY

According to one embodiment, a method, computer system, and computer program product for performance analysis of a commercial robot is provided. The present invention may include a processor that maps obstructions in a space to generate a map of obstructions, where the obstructions comprise data related to temporary obstacles during an operation of the commercial robot, and where the space comprises from a plurality of macro locations. The processor detects foot traffic and obstruction abnormalities in each of the plurality of macro locations from the map of obstructions. The processor compiles a correlation matrix from a set of feature vectors, wherein the set of feature vectors derived from the map of obstructions in the space. The processor determines a minimum duration time and a weekday for each of the plurality of macro locations based on the correlation matrix, where the minimum duration time is an optimum time and a weekday to dispatch the commercial robot in each of the plurality of macro locations.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a robot optimal performance analysis process according to at least one embodiment;

FIG. 3 is a block diagram of internal and external components of commercial robots and servers depicted in FIG. 1 according to at least one embodiment;

FIG. 4 depicts a cloud computing environment according to an embodiment of the present invention; and

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to commercial robot run time optimization using a variance method. The following described exemplary embodiments provide a system, method, and program product to, among other things, receive a plurality of data representing obstruction maps of the environment over time and determine an optimal run time for the commercial robot using an analysis of variance (ANOVA) method. Therefore, the present embodiment has the capacity to improve the technical field of optimizing a run time of a commercial robot by analyzing changes in obstructions over time and determining an optimal time for the robot to perform a task in order to improve an overall performance.

As previously described, a commercial robot is a machine that may be programmable by a computer and capable of carrying out a series of actions automatically. The commercial robot may be guided by an external control device or the control may be embedded within. Commercial robots may be autonomous or semi-autonomous that perform tasks in large areas such as cleaning, package delivery, or video surveillance. These robots are used, for example, in airports, hospitals, and factory shop floors.

Cleaning robots are being widely adopted in commercial and consumer environments, especially where the workforce is limited. For example, commercial cleaning robots are used in airports and hospitals where cleaning labor is in high demand. Typically, the commercial cleaning robots performance is affected by the amount of people traffic and other moving or static obstacles due to partial or a complete blockage of the cleaning areas. As such, it may be advantageous to, among other things, implement a system that divides the cleaning area into macro-locations and determines an optimal time period to perform tasks such as cleaning in each macro-location by using an ANOVA technique in order to determine the best time to dispatch the commercial cleaning robot in each macro-location.

According to one embodiment, a method, computer system, and computer program product for performance analysis of a commercial robot is provided. The present invention may include a processor that maps obstructions in a space to generate a map of obstructions, where the obstructions may relate to temporary obstacles data, collected during operation of the commercial robot that include foot traffic and obstruction abnormalities that may be detected in each of the plurality of macro locations from the map of obstructions. A correlation matrix from a set of feature vectors may be compiled from the data, where the set of feature vectors derived from the map of obstructions in the space. A preferred minimum duration time and a weekday for each of the plurality of macro locations may then be determined based on the correlation matrix where the minimum duration time is an optimum time and a weekday to dispatch the commercial robot in each of the plurality of macro locations.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, macrocode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to determine an optimal day and run time for the commercial robot based on applying an ANOVA method to the previously generated maps and obstacles.

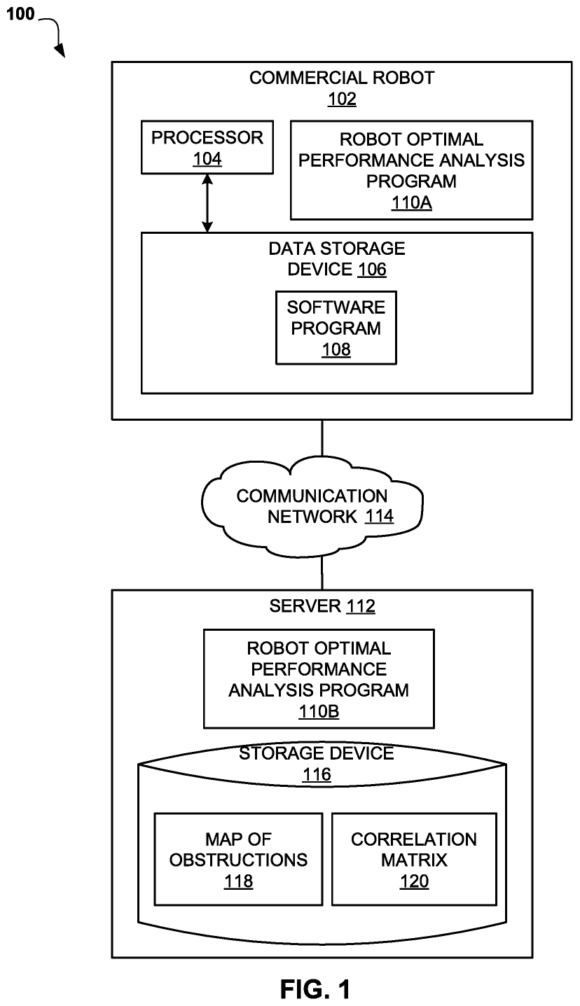

Referring to FIG. 1, an exemplary networked computer environment 100 is depicted, according to at least one embodiment. The networked computer environment 100 may include a commercial robot 102 and a server 112 interconnected via a communication network 114. According to at least one implementation, the networked computer environment 100 may include a plurality of commercial robots 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

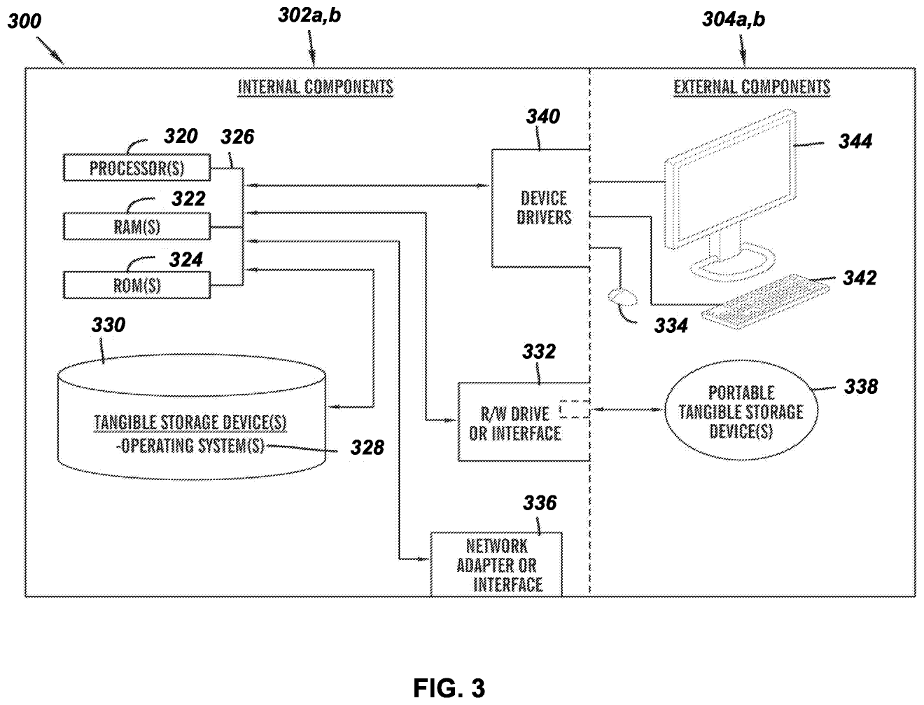

Commercial robot 102 may include a processor 104 and a data storage device 106 that is enabled to host and run a software program 108 and a Robot Optimal Performance Analysis (ROPA) program 110A and communicate with the server 112 via the communication network 114, in accordance with one embodiment of the invention. Commercial robot 102 may incorporate, for example, a mobile device, a telephone, a personal digital assistant, a netbook, a laptop computer, a tablet computer, a desktop computer, or any type of computing device capable of running a program and accessing a network. As will be discussed with reference to FIG. 3, the commercial robot 102 may include internal components 302a and external components 304a, respectively. Although not depicted in FIG. 1, commercial robot 102 may incorporate various sensors for map generation and obstacle avoidance. For example, commercial robot 102 may incorporate one or more infrared sensors, ultrasonic sensors, laser scanners, and cameras coupled with image processing software and hardware. According to an example embodiment, commercial robot 102 may gather data from various sensors and store it in map of obstructions 118 located on server 112.

The server computer 112 may be a laptop computer, netbook computer, personal computer (PC), a desktop computer, or any programmable electronic device or any network of programmable electronic devices capable of hosting and running a Robot Optimal Performance Analysis (ROPA) program 110B, storing data in storage device 116 and communicating with the commercial robot 102 via the communication network 114, in accordance with embodiments of the invention. As will be discussed with reference to FIG. 3, the server computer 112 may include internal components 302b and external components 304b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

The storage device 116 may be a tangible storage device 328 capable of storing map of obstructions 118 and correlation matrix 120. According to an example embodiment, the map of obstructions 118 may be a database that stores data from various sensors of the commercial robot 102 that may be represented as an area where commercial robot 102 operates. The map of obstructions 118 may include additional data such as a date when the robot was dispatched, the weekday when the robot was dispatched, duration of time and area where the robot operated and any other information from the sensors. Correlation matrix 120 may be a database or a file having a dataset in a tabulated format of the data extracted from the map of obstructions 118 for comparison based on the time and weekday in order to determine optimal performance of the commercial robot.

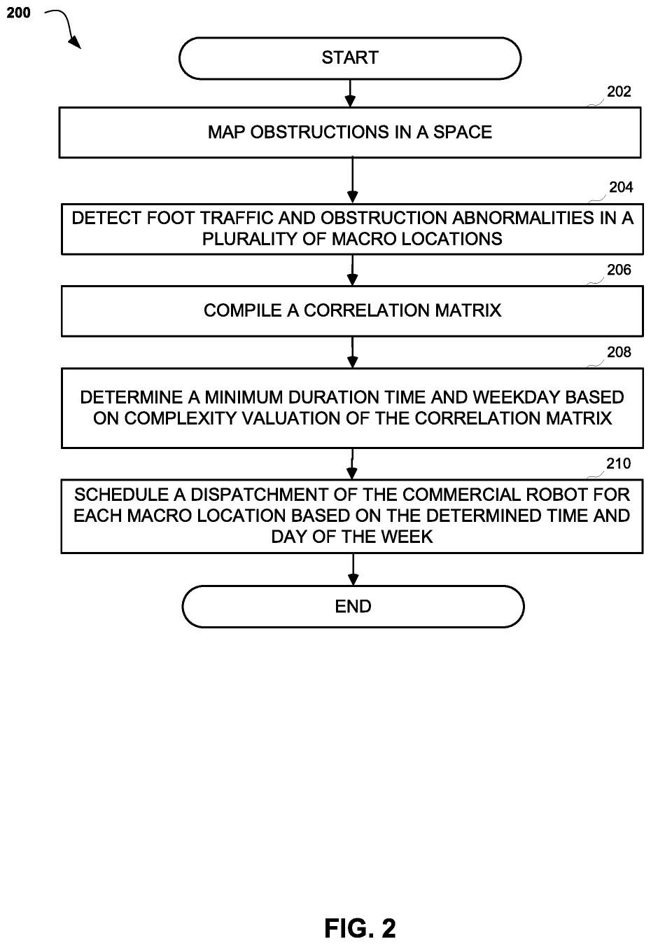

According to the present embodiment, the ROPA program 110A, 110B may be a program capable of using a machine learning technique to derive an optimal time and weekday for dispatching the commercial robot. The ROPA method is explained in further detail below with respect to FIG. 2.

Referring now to FIG. 2, an operational flowchart illustrating a robot optimal performance analysis process 200 is depicted according to at least one embodiment. At 202, the ROPA program 110A, 110B maps obstructions in a space. According to an example embodiment, ROPA program 110A, 110B may collect data from the various sensors associated with or communicatively coupled to the commercial robot 102 and store the collected data in the map of obstructions 118. In another embodiment, the ROPA program 110A, 110B may receive the map of obstructions 118 from that is stored on the server 112. The collected data may include robot dispatchment time, run time during operation, an area where the commercial robot operated, and a foot traffic during the operation that may be determined as temporary obstacles during operation. For example, in case commercial robot 102 is a cleaning robot, the map of obstructions 118 may include static and moving obstructions in a space, the time to clean a given space, the number of moving obstacles (e.g., foot traffic in the area) and the time and weekday associated with that moving obstacles. In addition, the map of obstructions 118 may include data related to an abnormal obstructions, where the abnormal obstructions are moving obstacles or obstacles that change location with time. Furthermore, ROPA program 110A, 110B may store the additional time required to clean around the abnormal obstructions or perform other designated tasks by the commercial robot.

Next, at 204, the ROPA program 110A, 110B detects foot traffic and obstruction abnormalities in a plurality of macro locations. According to an example embodiment, ROPA program 110A, 110B may divide the area where the commercial robot is dispatched into an array of areas (i.e., macro locations). For example, each room or enclosed area of the building may be assigned as a different macro location. According to an example embodiment, ROPA program 110A, 110B may detect foot traffic and abnormal obstructions by associating any moving obstacle as a person and comparing it to previously recorded data in the map of obstructions 118 that was recorded during different days of the week and time of operation of the commercial robot 102. In another embodiment, the ROPA program 110A, 110B may divide the space of the operation into an array of macro locations using geofencing techniques or user determined areas.

Then, at 206 ROPA program 110A, 110B compiles a correlation matrix. According to an example embodiment, the ROPA program 110A, 110B may generate feature vectors for each macro location. The feature vectors may be determined from the data derived from the map of obstructions 118 for each macro location separately (represented as “m” below) and may include:
(a) Weekday and time feature vector T_m={T1, T2, . . . , Tn}, where Tn represents previous weekday and time when the commercial robot started its operation in a specific macro space.
(b) Duration feature vector Dur_m={Dur_1, Dur_2, . . . , Dur_n}, where Dur_n represents a time duration it took for the commercial robot to complete the task in the specific macro space.
(c) Obstructions feature vector Ob_m={Ob_1, Ob_2, . . . , Ob_n}, where Ob_n represents a number of movable or all the obstructions faced during the time duration.
(d) Area feature vector A_m={A_1, A_2, . . . , A_n), where A_n represents a calculated or actual area of the macro space n covered by the commercial robot during the time duration.
(e) Dirt level feature vector D_m where each value represents a dirt level. For example, the values of D_m may be in a range from 1 to 5, where 1 represents a minimal level of dirt and 5 represents a maximum level of dirt. The dirt level may be determined either directly by using sensors such as camera or indirectly such as by determining the rate of weight increase of the garbage collecting bin of the commercial robot.

According to an example embodiment, the ROPA program 110A, 110B may generate a correlation matrix for each macro location m and store the generated correlation matrix in correlation matrix 120 in a tabulated format for subsequent comparison. For example, the ROPA program 110A, 110B may generate a correlation matrix using one or more of: weekday and time feature vector; duration feature vector; obstructions feature vector; area feature vector; and dirt level feature vector.

Next, at 208, the ROPA program 110A, 110B determines a minimum duration time and weekday based on a complexity valuation of the correlation matrix. According to an example embodiment, the ROPA program 110A, 110B may perform a complexity valuation of the correlation matrix for each macro location m by using the following logic: If a dirt level D_m and weekday and time T_m is equal to the dirt level recorded for a different day D_m′ and different weekday and time T_m′ for the same macro location represented by an area A_m then the ROPA program 110A, 110B may compare the values representing number of obstructions Ob_m to Ob_m′ and determine a difference between Dur_m and Dur_m′. If a dirt levels D_m were comparable to D_m′ and Dur_m<Dur_m′ then specific weekday and time T_m is recorded and stored as the optimum time to dispatch the commercial robot for the macro location m. In another embodiment, the ROPA program 110A, 110B may analyze the correlation matrix and determine the minimum duration time and weekday based on analyzing obstruction feature vector values and choosing the time and weekday corresponding to a minimum value determined in the obstruction feature vector.

According to an example embodiment, the ROPA program 110A, 110B may perform the logic of step 208 in a loop and compare all the recorded data for each macro location m during different weekdays and times the commercial robot was dispatched during a learning period. In another embodiment, the ROPA program 110A, 110B may determine and store only the optimal weekday, time and duration after each completion of a task by commercial robot for each macro location m. In a further embodiment, the ROPA program 110A, 110B may use any other available technique to determine the minimum duration time and weekday for the commercial robot to perform the task by analyzing correlation matrices stored in correlation matrix 120.

Next, at 210, ROPA program 110A, 110B schedules a dispatchment of the commercial robot for each macro location m based on the determined time and weekday. According to an example embodiment, the ROPA program 110A, 110B uses the determined specific weekday and time T_m for each macro location to dispatch the commercial robot. In another embodiment, the ROPA program 110A, 110B may determine an average weekday and time to dispatch the commercial robot for the space (total area) based on the optimal time and date of the week for the biggest area value of the macro location. In further embodiment, the ROPA program 110A, 110B may determine a sequence of dispatching of the robot in each macro location m based on the determined weekday and time.

It may be appreciated that FIG. 2 provides only an illustration of one implementation and does not imply any limitations with regard to how different embodiments may be implemented. Many modifications to the depicted environments may be made based on design and implementation requirements.

FIG. 3 is a block diagram 300 of internal and external components of the commercial robot 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 302, 304 is representative of any electronic device capable of executing machine-readable program instructions. The data processing system 302, 304 may be representative of a smart phone, a computer system, PDA, or other electronic devices. Examples of computing systems, environments, and/or configurations that may represented by the data processing system 302, 304 include, but are not limited to, personal computer systems, server computer systems, thin clients, thick clients, hand-held or laptop devices, multiprocessor systems, macro processor-based systems, network PCs, minicomputer systems, and distributed cloud computing environments that include any of the above systems or devices.

The commercial robot 102 and the server 112 may include respective sets of internal components 302 a,b and external components 304 a,b illustrated in FIG. 3. Each of the sets of internal components 302 include one or more processors 320, one or more computer-readable RAMs 322, and one or more computer-readable ROMs 324 on one or more buses 326, and one or more operating systems 328 and one or more computer-readable tangible storage devices 330. The one or more operating systems 328, the software program 108 and the ROPA program 110A in the commercial robot 102, and the ROPA program 110B in the server 112 are stored on one or more of the respective computer-readable tangible storage devices 330 for execution by one or more of the respective processors 320 via one or more of the respective RAMs 322 (which typically include cache memory). In the embodiment illustrated in FIG. 3, each of the computer-readable tangible storage devices 330 is a magnetic disk storage device of an internal hard drive. Alternatively, each of the computer-readable tangible storage devices 330 is a semiconductor storage device such as ROM 324, EPROM, flash memory or any other computer-readable tangible storage device that can store a computer program and digital information.

Each set of internal components 302 a,b also includes a R/W drive or interface 332 to read from and write to one or more portable computer-readable tangible storage devices 338 such as a CD-ROM, DVD, memory stick, magnetic tape, magnetic disk, optical disk or semiconductor storage device. A software program, such as the cognitive screen protection program 110A, 110B, can be stored on one or more of the respective portable computer-readable tangible storage devices 338, read via the respective R/W drive or interface 332, and loaded into the respective hard drive 330.

Each set of internal components 302 a,b also includes network adapters or interfaces 336 such as a TCP/IP adapter cards, wireless Wi-Fi interface cards, or 3G or 4G wireless interface cards or other wired or wireless communication links. The software program 108 and the ROPA program 110A in the commercial robot 102 and the ROPA program 110B in the server 112 can be downloaded to the commercial robot 102 and the server 112 from an external computer via a network (for example, the Internet, a local area network or other, wide area network) and respective network adapters or interfaces 336. From the network adapters or interfaces 336, the software program 108 and the ROPA program 110A in the commercial robot 102 and the ROPA program 110B in the server 112 are loaded into the respective hard drive 330. The network may comprise copper wires, optical fibers, wireless transmission, routers, firewalls, switches, gateway computers and/or edge servers.

Each of the sets of external components 304 a,b can include a computer display monitor 344, a keyboard 342, and a computer mouse 334. External components 304 a,b can also include touch screens, virtual keyboards, touch pads, pointing devices, and other human interface devices. Each of the sets of internal components 302 a,b also includes device drivers 340 to interface to computer display monitor 344, keyboard 342, and computer mouse 334. The device drivers 340, R/W drive or interface 332, and network adapter or interface 336 comprise hardware and software (stored in storage device 330 and/or ROM 324).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

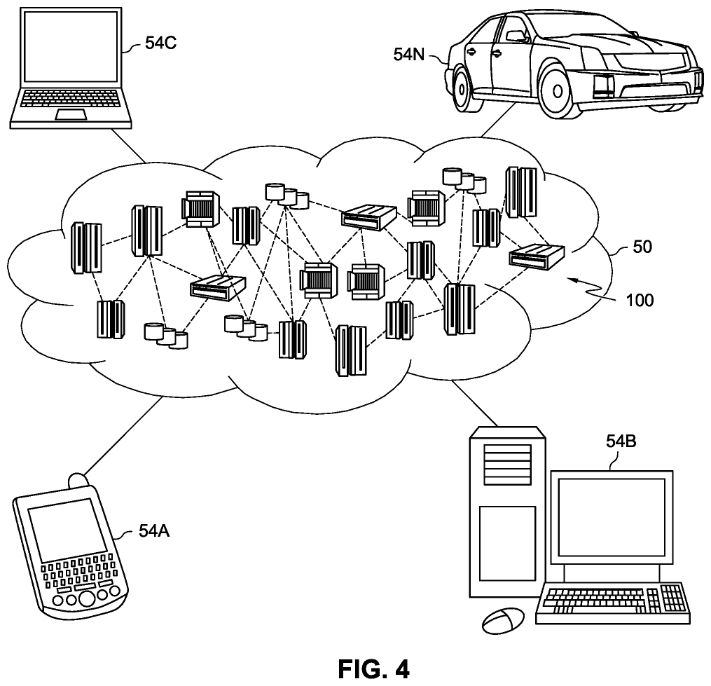

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

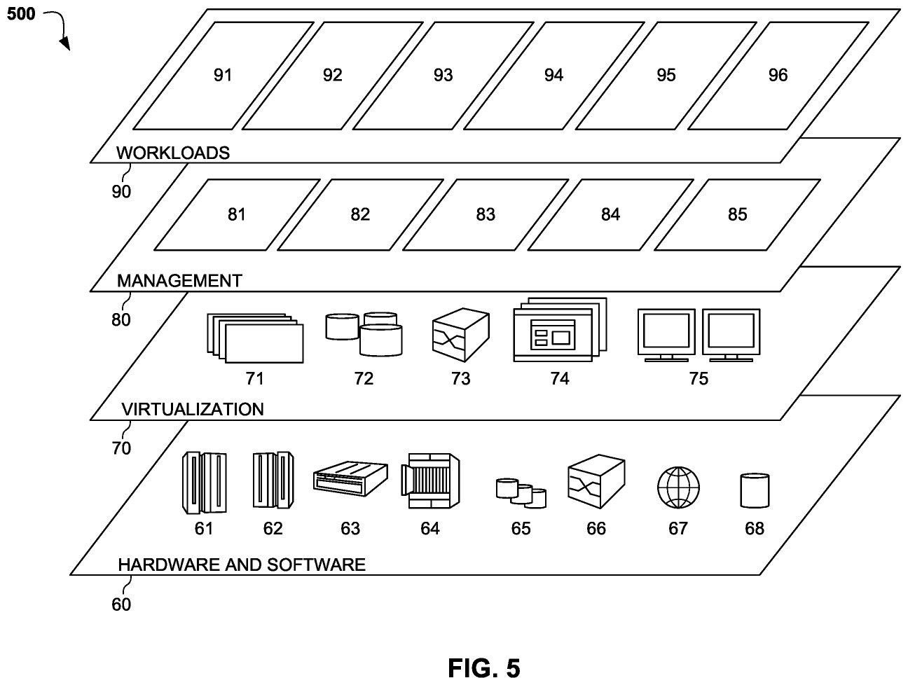

Referring now to FIG. 5, a set of functional abstraction layers 500 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and robot performance analysis 96. Robot performance analysis 96 may relate to converting previous maps of obstructions of the commercial robot into a correlation matrix for each of a series of macro locations and using a complexity variation determining a minimum time duration, time, and day when the commercial robot should be dispatched in order to achieve an optimal performance.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for performance analysis of a commercial robot, the method comprising:
mapping a plurality of obstructions in a space;
generating a map of obstructions from the mapped plurality of obstructions, wherein the map of obstructions comprises data related to temporary obstacles during an operation of the commercial robot, and wherein the space comprises a plurality of macro locations;
detecting foot traffic and obstruction abnormalities in each of the plurality of macro locations from the map of obstructions;
compiling a correlation matrix from a set of feature vectors, wherein the set of feature vectors derived from the map of obstructions in the space; and
determining a minimum duration time and a weekday for each of the plurality of macro locations based on the correlation matrix, wherein the minimum duration time is an optimum time and a weekday to dispatch the commercial robot in each of the plurality of macro locations.

2. The method of claim 1, wherein the map of obstructions is a database that comprises data related to static and moving obstructions in the space, time duration to clean the plurality of macro locations, a number of moving obstacles, and a time and a weekday associated with the plurality of macro locations.

3. The method of claim 1, further comprising scheduling a dispatchment of the commercial robot for each of the plurality of macro locations based on the determined minimum duration time and the weekday.

4. The method of claim 1, wherein the set of feature vectors comprises:
a weekday and time feature vector;
a duration feature vector;
an obstructions feature vector;
an area feature vector; and
a dirt level feature vector.

5. The method of claim 1, wherein determining the minimum duration time and the weekday for each of the plurality of macro locations based on the correlation matrix further comprises:
determining a minimum value of an obstruction feature vector for each of the plurality of macro locations; and
determining the minimum duration time and the weekday for each of the plurality of macro locations based on the minimum value of the obstruction feature vector in the correlation matrix.

6. The method of claim 1, wherein the plurality of macro locations are determined by dividing the space using geofencing techniques.

7. The method of claim 1, wherein the correlation matrix is a file having a dataset in a tabulated format of data extracted from the map of obstructions.

8. A computer system for performance analysis of a commercial robot, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
mapping a plurality of obstructions in a space;
generating a map of obstructions from the mapped plurality of obstructions, wherein the map of obstructions comprises data related to temporary obstacles during an operation of the commercial robot, and wherein the space comprises a plurality of macro locations;
detecting foot traffic and obstruction abnormalities in each of the plurality of macro locations from the map of obstructions;
detecting foot traffic and obstruction abnormalities in each of the plurality of macro locations from the map of obstructions;
compiling a correlation matrix from a set of feature vectors, wherein the set of feature vectors derived from the map of obstructions in the space; and
determining a minimum duration time and a weekday for each of the plurality of macro locations based on the correlation matrix, wherein the minimum duration time is an optimum time and a weekday to dispatch the commercial robot in each of the plurality of macro locations.

9. The computer system of claim 8, wherein the map of obstructions is a database that comprises data related to static and moving obstructions in the space, time duration to clean the plurality of macro locations, a number of moving obstacles, and a time and a weekday associated with the plurality of macro locations.

10. The computer system of claim 8, further comprising scheduling a dispatchment of the commercial robot for each of the plurality of macro locations based on the determined minimum duration time and the weekday.

11. The computer system of claim 8, wherein the set of feature vectors comprises:
a weekday and time feature vector;
a duration feature vector;
an obstructions feature vector;
an area feature vector; and
a dirt level feature vector.

12. The computer system of claim 8, wherein determining the minimum duration time and the weekday for each of the plurality of macro locations based on the correlation matrix further comprises:
determining a minimum value of an obstruction feature vector for each of the plurality of macro locations; and
determining the minimum duration time and the weekday for each of the plurality of macro locations based on the minimum value of the obstruction feature vector in the correlation matrix.

13. The computer system of claim 8, wherein the plurality of macro locations are determined by dividing the space using geofencing techniques.

14. The computer system of claim 8, wherein the correlation matrix is a file having a dataset in a tabulated format of data extracted from the map of obstructions.

15. A computer program product for performance analysis of a commercial robot, the computer program product comprising:
one or more computer-readable tangible storage medium and program instructions stored on at least one of the one or more tangible storage medium, the program instructions executable by a processor, the program instructions comprising:
program instructions to map a plurality of obstructions in a space;
program instructions to generate a map of obstructions from the mapped plurality of obstructions, wherein the map of obstructions comprises data related to temporary obstacles during an operation of the commercial robot, and wherein the space comprises a plurality of macro locations;
program instructions to detect foot traffic and obstruction abnormalities in each of the plurality of macro locations from the map of obstructions;
program instructions to detect foot traffic and obstruction abnormalities in each of the plurality of macro locations from the map of obstructions;
program instructions to compile a correlation matrix from a set of feature vectors, wherein the set of feature vectors derived from the map of obstructions in the space; and
program instructions to determine a minimum duration time and a weekday for each of the plurality of macro locations based on the correlation matrix, wherein the minimum duration time is an optimum time and a weekday to dispatch the commercial robot in each of the plurality of macro locations.

16. The computer program product of claim 15, wherein the map of obstructions is a database that comprises data related to static and moving obstructions in the space, time duration to clean the plurality of macro locations, a number of moving obstacles, and a time and a weekday associated with the plurality of macro locations.

17. The computer program product of claim 15, further comprising program instructions to schedule a dispatchment of the commercial robot for each of the plurality of macro locations based on the determined minimum duration time and the weekday.

18. The computer program product of claim 15, wherein the set of feature vectors comprises:
a weekday and time feature vector;
a duration feature vector;
an obstructions feature vector;
an area feature vector; and
a dirt level feature vector.

19. The computer program product of claim 15, wherein program instructions to determine the minimum duration time and the weekday for each of the plurality of macro locations based on the correlation matrix further comprises:
program instructions to determine a minimum value of an obstruction feature vector for each of the plurality of macro locations; and
program instructions to determine the minimum duration time and the weekday for each of the plurality of macro locations based on the minimum value of the obstruction feature vector in the correlation matrix.

20. The computer program product of claim 15, wherein the plurality of macro locations are determined by dividing the space using geofencing techniques.
